(19) United States
(12) Patent Application Publication
(10) Pub. No.: US 2014/0309076 A1
(43) Pub. Date: Oct. 16, 2014

(54) DIFFERENTIAL GEAR

(71) Applicant: Schaeffler Technologies GmbH & Co. KG, Herzogenaurach (DE)

(72) Inventors: Ralph Schimpf, Fuerth (DE); Thorsten Biermann, Wachenroth (DE); Franz Kurth, Nuernberg (DE)

(73) Assignee: Schaeffler Technologies GmbH & Co. KG, Herzogenaurach (DE)

(21) Appl. No.: 14/226,478

(22) Filed: Mar. 26, 2014

(30) Foreign Application Priority Data
Apr. 16, 2013 (DE) 102013206753.4

(51) Int. Cl. F16H 48/22

(52) U.S. Cl. CPC F16H 48/22
USPC 475/246

(57) ABSTRACT

A differential gear having a gear housing, an epicyclic gear housing which is arranged in the gear housing in a manner allowing rotation about a gear axis, and a planetary carrier which sits in the epicyclic gear housing, wherein the drive power applied to the epicyclic gear housing is divided by means of this differential gear, and the planetary carrier and the epicyclic gear housing can be coupled selectively by force fit via a coupling device. The differential gear has a brake device with a brake disk pack for the purpose of generating a coupling torque which couples the planetary carrier to the epicyclic gear housing, and an actuating mechanism for the purpose of generating an axial force which engages the brake device, wherein the bearing device has a first roller bearing with an outer bearing ring fixed to the gear housing.

### CROSS-REFERENCE TO RELATED APPLICATIONS

This patent claims priority from German Patent Application No. 10 2013 206 753.4 filed on Apr. 16, 2013, which application is incorporated herein by reference its entirety.

### FIELD OF THE INVENTION

The invention relates to a differential gear having a gear housing, an epicyclic gear housing which is arranged in the gear housing in a manner allowing rotation about a gear axis, and a planetary carrier which sits in the epicyclic gear housing, wherein the drive power applied to the epicyclic gear housing is split by means of this differential gear, and the planetary carrier and the epicyclic gear housing can be selectively coupled to each other by a friction fit via a coupling device.

### BACKGROUND OF THE INVENTION

Differential gears are generally constructed as planetary wheels, and most commonly serve the purpose of splitting or distributing an input power, supplied by a power input, to two drive shafts. Differential gears are most frequently used in the building of automobiles as so-called axle differentials. In this case, drive power supplied by a drive motor is distributed via the differential gear to wheel drive shafts of driven wheels. The two wheel drive shafts leading to the wheels in this case are each driven at the same torque, meaning they are balanced. When the vehicle drives straight forward, both wheels rotate at the same speed. When the vehicle travels a curve, the rotation speeds of each wheel are different. The axle differential makes this rotation speed difference possible. The rotation speeds are able to adjust themselves freely; only the average of the two speeds is unchanged.

In certain applications, particularly in all-wheel drive vehicles, differential gears are used which enable a switchable decoupling when the all-wheel drive function is not necessary, and additionally enable a separation in the drivetrain in order to drive the vehicle via only one axle, thereby reducing friction loss in the drive system, the same being not necessary at the moment, but otherwise driven anyway. Such a differential gear is known from DE 10 2008 037 885 A1, by way of example.

The problem addressed by the invention is that of creating a differential gear which enables a switchable release of the drive connection between the power input and the two power outputs, and which is characterized by an advantageous construction with respect to the internal guidance of forces.

### BRIEF SUMMARY OF THE INVENTION

The problem named above is addressed according to the invention by a differential gear, having a gear housing, an epicyclic gear housing which is arranged in the gear housing in a manner allowing rotation about a gear axis, a bearing device for the purpose of mounting the epicyclic gear housing in the gear housing, a planetary carrier arranged in the epicyclic gear housing coaxially to the gear axle, a brake device having a brake disk pack for the purpose of generating a coupling torque which couples the planetary carrier to the epicyclic gear housing, and an actuating mechanism for the purpose of generating an axial force which engages the brake device, wherein the bearing device has a first roller bearing with an outer bearing ring fixed to the gear housing, and the axial force which engages the brake device is guided via a first axial bearing which is supported on a radial end face of the first outer bearing ring of the first roller bearing.

In this way, it is advantageously possible to create a differential gear wherein it is possible for the axial forces which are necessary to bring about the coupled state of the brake device to be advantageously directed into the gear housing via the outer bearing ring of the first bearing. This first roller bearing is preferably designed as an angular roller bearing which bears radially and axially. As an alternative to this configuration, it is also possible for the first roller bearing to be designed as a tapered roller bearing which bears radially and axially, or particularly as an angular cylinder roller bearing.

According to one particularly preferred embodiment of the invention, the first axial bearing is designed as a cylinder roller bearing, the cylinder rollers of which roll directly on the end face of the first outer bearing ring. The cylinder rollers themselves are preferably guided in a cage device. The cage device in this case can be designed in such a manner that it forms a retaining device which as such properly holds the roller elements together during the assembly of the gearing—or in an event where the epicyclic gear housing otherwise moves away from the outer bearing ring axially.

The differential gear according to the invention is furthermore preferably designed in such a manner that the first axial bearing comprises a first axial bearing race, wherein the roller elements of the first axial bearing are supported axially on said race. This axial bearing race can form a groove in cross-section, the base surface of which constitutes the raceway for the roller elements. The roller elements are advantageously guided radially, and also in a manner preventing their loss, in this groove cross-section.

A second axial bearing is advantageously included on a side of the epicyclic gear housing which is opposite the first axial bearing. This second axial bearing can in turn be designed in such a manner that it comprises a second axial bearing race which has the same design as the axial bearing race named above. The roller elements of this second axial bearing preferably run on the end face of an annular piston which as such serves the purpose of generating an axial force which selectively loads the brake disk pack.

In a particularly preferred embodiment of the invention, the differential gear according to the invention is designed as a spur gear differential gear and has a first output sun gear, a second output sun gear, and a planet arrangement accommodated in the planetary carrier, for the purpose of coupling the two output sun gears to each other in a manner allowing rotation in opposite directions.

The planet arrangement is preferably designed in turn in such a manner that it has multiple revolving planets which, as such, are able to rotate about planetary axes which are oriented parallel to the gear axle. The brake device is designed in such a manner that the brake disk pack is positioned at the radial distance of the planetary axes.

The first axial bearing in this case is preferably designed in such a manner that the raceway diameter of the first axial bearing race is positioned at the radial distance of the brake disk pack.

According to one particular aspect of the present invention, the epicyclic gear housing which is mounted in the gear housing in a manner allowing rotation about a gear axis is designed as a bowl housing, wherein the transmission of axial force between the planetary carrier and the first axial bearing raceway is realized via plunger elements which are guided through a base surface of the bowl housing with axial float.

The differential gear according to the invention is advantageously constructed in such a manner that the brake disk pack is composed of brake disks designed as annular disks. These brake disks can be designed as flat steel sheet metal hollow disks, which are optionally coated with a friction material layer. The brake disk pack in this case can be constructed in such a manner that it comprises brake disks which are kinematically coupled to the planetary carrier via an inner peripheral contour, in a manner allowing axial displacement, but which is nevertheless non-rotatable. In addition, the brake disk pack then also comprises brake disks which are kinematically coupled to the epicyclic gear housing via an outer peripheral contour, in a manner allowing axial displacement, but which is nevertheless non-rotatable.

According to one particularly preferred embodiment of the invention, the axial support of the brake disk pack is realized in interaction with a pressure ring element, wherein this pressure ring element is supported on the end faces of the planet pins.

The epicyclic gear housing which is included for the purpose of receiving the planetary carrier, as indicated above, is preferably designed as a two-part bowl housing which is composed of a first bowl element and a second bowl element, wherein the first bowl element has a base section which extends inward radially. This base section of the first bowl element can be configured with cylindrical passages which pass through the base section sequentially at points evenly distributed around the periphery. Plunger elements of a first set of plunger elements can be received in these passages, wherein the plunger elements are guided in the passages in a manner allowing axial sliding toward the planet axes. These plunger elements function as pressure transmission organs between the interior of the bowl housing and the exterior of the same.

The roller guide ring which is preferably seated on the plunger elements, on a side of the same which is opposite the brake disk pack, can be loaded axially via an annular piston element for the purpose of axially compressing the brake disk pack. This annular piston element is preferably received in a circular chamber which is concentric to the gear axle, and able to move axially according to the magnitude of a fluid pressure applied to the circular chamber. This annular piston presses the rollers of the roller guide ring, wherein said rollers run on the same, into the planetary carrier—meaning in the direction of the brake disk pack—when the fluid pressure is adequate.

According to one particularly advantageous embodiment, the planetary carrier is likewise supported on the side thereof which is opposite the brake disk pack by plunger elements, which in turn are guided through a base surface of the epicyclic gear housing, and supported on the end face thereof on the first roller ring. These plunger elements can have the same construction as the first plunger elements named above.

A ring gear is preferably seated on the epicyclic gear housing. The power input into the epicyclic gear housing is realized via this ring gear. A right-angled drive can be implemented with an interface to this ring gear. This construction is particularly suitable for use as a rear differential which can be reversibly disengaged. It is also possible to arrange a spur gear on the epicyclic gear housing in the place of the ring gear, for the purpose of inputting the drive power.

The inner differential included in this case, the same accommodated in the interior of the epicyclic gear housing, is designed as a spur gear differential having two output sun gears which are able to rotate in opposite directions, via a planetary arrangement. This spur gear differential is, according to a particularly preferred embodiment of the invention, designed with a Wildhaber/Novikov toothing. Details on the geometries which are preferably implemented on the respective toothed wheels in this case, as well as the addendum and foot circle diameters of the output sun gears and the revolving planet gears which engage with the same, are explained in the description of the figures.

### BRIEF DESCRIPTION OF THE DRAWINGS

Further details and features of the invention are found in the following description, with reference to the drawing, wherein:

FIG. 1 shows an axial cutaway view which clarifies the construction of a differential gear according to the invention, wherein the coupling of the planetary carrier to a bowl housing which receives the same is realized via a brake disk pack, which extends along the radial distance or track of the planet gear bearing pin axes with respect to the gear axle, wherein the axial directing of the axial force which engages the brake disk pack, into the stationary gear housing, occurs via an axial bearing which is supported axially on an outer bearing ring of a bearing which bears the epicyclic gear housing.

### DETAILED DESCRIPTION OF THE INVENTION

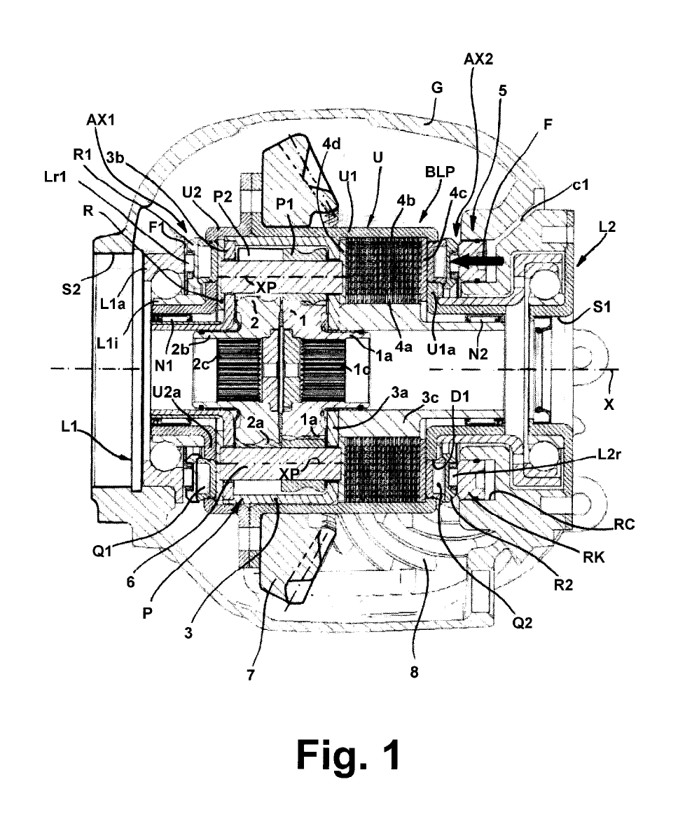

The illustration according to FIG. 1 shows a differential gear according to the invention. The same has a gear housing G and an epicyclic gear housing U which is mounted in the gear housing G in a manner allowing rotation about a gear axis X. A planetary carrier 3 is received in the epicyclic gear housing U, which in turn is arranged coaxially to the gear axle X.

The differential gear further comprises a first output sun gear 1, a second output sun gear 2, and a planetary arrangement P accommodated in the planetary carrier 3, for the purpose of coupling the two output sun gears 1, 2 in a manner allowing rotation in opposite directions. A brake device is positioned in the differential gear, which in this case is designed as a brake disk pack BLP, for the purpose of generating a coupling torque which selectively couples the planetary carrier 3 to the epicyclic gear housing U, according to the magnitude of an axial force F engaging the brake disk pack BLP.

In addition, the differential gear according to the invention has an actuating mechanism 5 for the purpose of generating the axial force F applied to the brake disk pack BLP. The brake disk pack BLP is integrated into the differential gear in such a manner that it couples the planetary carrier 3 to the epicyclic gear housing U with a friction fit when there is a corresponding axial load. As a result of this approach, it is possible to release the drive connection between the planetary carrier 3 and the epicyclic gear housing U by unloading the brake disk pack BLP and/or to couple the planetary carrier 3 to the epicyclic gear housing U with a friction fit by means of loading the brake disk pack BLP axially.

The differential gear which in this case includes the planetary carrier 3, the planetary arrangement P and the output sun gears 1, 2 is designed as a spur gear differential with two output sun gears 1, 2. The planetary arrangement P has multiple revolving planets P1, P2 which are mounted as such on planet pins 6.

The mounting of the epicyclic gear housing U in the gear housing G is realized via a bearing device L1, L2, which in this case has a first roller bearing L1 which bears axially and radially and is designed as an angular roller bearing, the same having an inner bearing ring L1i and an outer bearing ring L1a which is fixed to the gear housing G. The axial force F which engages the brake device is directed according to the invention via a first axial bearing AX1 which is supported on a radial end face F1 of the first outer bearing ring L1a of the first roller bearing L1.

This first axial bearing AX1 in this case is designed as a cylindrical roller bearing. The cylindrical rolls L1r of the cylindrical roller bearing roll directly on the end face F1 of the first outer bearing ring L1a. The first axial bearing AX1 has a first axial bearing race R1 on which the roller elements L1r of the first axial bearing AX1 are likewise axially supported.

A second axial bearing AX2 is included on a side of the epicyclic gear housing U which is opposite the first axial bearing AX1. This second axial bearing AX2 has a second axial bearing race R2. The roller elements L2r of the second axial bearing AX2 are supported axially on the annular piston RK.

The planetary arrangement P comprises multiple revolving planets P1, P2 which as such are able to rotate about planetary axes XP which are oriented parallel to the gear axle X. The brake device is designed in such a manner that the brake disk pack BLP is positioned at the radial distance of the planetary axes XP1. The raceway of the first axial bearing race R1 is likewise positioned at the radial distance of the brake disk pack.

The epicyclic gear housing U is designed as a bowl housing, and the transmission of axial force between the planetary carrier 3 and the first axial bearing race R1 is realized via plunger elements Q1 which are guided through a base surface of the bowl housing with axial float.

In the differential gear according to the invention, the brake disk packs BLP and the planetary carrier 3 are designed to match each other in such a manner that the brake disk pack BLP is positioned at the radial distance or track distance of the planetary axes XP which are parallel to the gear axle X. As a result of this special construction, it is possible for the axial force F which engages the brake disk pack BLP to be directed through the planetary carrier 3 axially to the race R1, “extended in a straight line,” while incorporating the planet pins 6 which are oriented parallel to the gear axle X.

The brake disk pack BLP has a set of first, annular brake disks 4a which engage with the planetary carrier 3 via an inner edge contour thereof, in a non-rotatable manner, but nevertheless allowing axial sliding. The brake disk pack BLP has a set of second brake disks 4b which engage with the epicyclic gear housing U via an outer edge contour, in a non-rotatable manner, but nevertheless allowing axial sliding. These brake disks 4a, 4b are designed as flat steel sheet metal hollow disks, and preferably are coated with a friction material layer.

The axial support of the brake disk pack BLP on the planet pins 6 is realized with the integration of a pressure ring element 4d which is supported on the end faces of the planet pins 6. The planetary carrier 3 and the brake disk pack BLP are matched to each other in such a manner that the radial distance of each of the planet pin axes XP from the gear axle X is greater than the inner diameter of a brake disk 4a, 4b, and also is smaller than the outer diameter of the brake disk 4a, 4b.

The epicyclic gear housing U included for the purpose of receiving the planetary carrier 3 is designed as a two-part bowl housing, and composed of a first bowl element U1 and a second bowl element U2, wherein the first bowl element U1 has a base section U1a which extends inward radially. This base section U1a of the first bowl element U1 in this case is configured with circular passages D1 which pass through said base section U1a in sequential positions at equal distances around the periphery. The plunger elements Q2 of a set of plunger elements sit in these passages D1. These plunger elements Q2 are guided in the passages D1 in a manner allowing axial sliding in the direction of the planet axes XP. These plunger elements Q2 function as pressure transmission organs between the inner region of the bowl housing U and the outer region of the same. A roller guide ring R2 is seated on a side of the plunger elements Q2, on these plunger elements Q2, said side being opposite the brake disk pack BLP, wherein said roller guide ring R2 can be loaded axially via the annular piston RK, with the rollers L2r connected in-between, for the purpose of axially compressing the brake disk pack BLP.

The annular piston element RK is received in a circular chamber RC which is concentric with the gear axle X, and can be moved axially according to the magnitude of a fluid pressure applied to the circular chamber RC via a fluid channel C1. This annular piston element RK impels the rollers L2r of the roller guide ring R2, said rollers L2r running on the same, toward the planetary carrier 3—meaning in the direction of the brake disk pack BLP. The circular chamber RK above is directly molded into the gear housing G in this case.

The planetary carrier 3 is likewise supported by plunger elements Q1 on the side thereof which is opposite the brake disk pack BLP, said plunger elements Q1 in turn being guided through a base surface U2a of the epicyclic gear housing U and supported on the end face thereof by the first roller ring R1. These plunger elements Q1 are designed with the same construction as the plunger elements Q2 named above.

The roller ring R1 carries a roller arrangement L1r which runs directly on an end face of an outer bearing ring L1a of a bearing L1 which supports the epicyclic gear housing U. The roller ring R1 can be designed in such a manner that it is centered by the inner bearing ring L1i of this bearing L1. In the embodiment shown here, the inner bearing ring L1i receives the radial and axial forces which act on the epicyclic gear housing U. The axial bearing AX1 receives the axial forces of the brake disk pack BLP which are transmitted out of the epicyclic gear housing U via the floating plunger elements Q1. The axial load of the first bearing device L1 is therefore not additionally loaded by the actuating forces generated by the annular piston element RK.

The plunger elements Q1, Q2 can be partially seated in suitable receiving pockets of the roller rings R1, R2, and optionally secured, to prevent them from falling out, in the same. A locking device can be implemented by means of the plunger elements Q1, Q2 in relation to the roller rings R1, R2, such that the roller rings R1, R2 are able to travel axially together with the plunger elements Q1, Q2 functionally assigned to the same, but are not able to rotate with respect to the epicyclic gear housing U.

The first and second revolving planets P1, P2 named above engage directly with each other, and are therefore coupled in a driving relationship to each other, in such a manner that they rotate in opposite directions. In this embodiment, there are a total of three revolving planets P1 which engage with the first output sun gear 1. These revolving planets P1 which engage with the first output sun gear 1 form a first set of revolving planets. In addition, in this embodiment, there are a total of three revolving planets P2 which engage with the second output sun gear 2. These revolving planets P2 which engage with the second output sun gear 2 form a second set of revolving planets. Each revolving planet P1 of the first set engages with one revolving planet P2 of the second set. The engagement of the revolving planets P1 of the first set with the revolving planets P2 of the second set is realized at the same tooth plane as the engagement of the revolving planets P1 of the first set with the output sun gear 1.

The first output sun gear 1 and the second output sun gear 2 are matched to each other, in regards to the tooth geometry thereof, in such a manner that the addendum circle of the spur gear toothing 1a of the first output sun gear 1 is smaller than the root circle of the output sun gear toothing 2a of the second output sun gear 2. The revolving planets P1 of the first set engage with the revolving planets P2 of the second set in the region of the tooth plane of the first output sun gear 1. The two output sun gears 1, 2 are directly adjacent to each other.

The two output sun gears 1, 2 are designed in such a manner that the output sun gear toothing 1a of the first output sun gear 1, and the output sun gear toothing 2a of the second output sun gear 2 have the same number of teeth. The revolving planets P1 of the first set and the revolving planets P2 of the second set also have the same number of teeth. The input of the drive power into the differential gear is realized via the ring gear 7 and the epicyclic gear housing U. A symmetrical division of torque, and a division of power to the output sun gears 1, 2 is realized via the revolving planets P1, P2. Flange sections 1b, 2b are constructed on the output sun gears 1, 2. These flange sections 1b, 2b are configured with an inner toothing 1c, 2c. End segments of wheel drive shafts or other power transfer components of the respective wheel drivetrain can be inserted into this inner toothing 1c, 2c, said end segments accordingly having complementary toothing. In place of the inner toothing shown here, other connection geometries can also be possible for the transmission of rotational torque, and for centering and receiving corresponding components.

The ring gear 7 seated on the epicyclic gear housing U in a non-rotatable manner is driven via a primary drive sprocket 8. The ring gear 7 and the primary drive sprocket 8 form a right-angled drive. The embodiment shown here is therefore particularly suitable as an axle differential for a rear axle which can be selectively decoupled from the primary drivetrain. In place of the transmission of rotary torque via a right-angled drive indicated here, it is also possible for a spur gear to be configured on the epicyclic gear housing U, which is driven via a further spur gear, by way of example. Such a variant is then particularly suitable for direct installation in a vehicle transmission.

The planetary carrier 3 sits between the ring element R and the brake disk pack BLP. The axial force transmission between the ring element R and the brake disk pack BLP is realized in this case primarily via the planet pins 6 and the planetary carriers 3 themselves, braced by the same.

The planetary carrier 3 is composed of two carrier jackets 3a, 3b and a carrier pin 3c. The carrier jackets 3a, 3b are each produced as molded sheet metal parts. These two carrier jackets 3a, 3b and the carrier pins 3c are welded to each other. For this purpose, rods are formed on the first carrier jacket 3a, which as such bridge the tooth region. The first carrier jacket 3a forms an inner bore hole in which an extension of the first output sun gear 1 is accommodated in a manner allowing rotation. The brake disk pack BLP sits on the carrier pin 3c. When the brake disk pack BLP is fully braked, the planetary carrier 3 can therefore be coupled by a friction fit to the epicyclic gear housing U. The brake disk pack BLP and the actuating mechanism 5 which is configured to load the same axially are designed in such a manner that it is possible for the drive torque applied to the ring gear 7 to be transmitted to the planetary carrier 3 via the brake disk pack BLP when the same is loaded axially.

The mounting of the planetary carrier 3 in the epicyclic gear housing U is realized via a first needle roller bearing N1 and a second needle roller bearing N2. The mounting of the epicyclic gear housing U in the gear housing G is realized via the angular ball bearings L1, L2. These angular ball bearings L1, L2 direct the gear reaction force components, which engage the ring gear 7 and are oriented axially and radially, into the gear housing G. Neither the bearing N1 nor the bearing N2 needs to convey axial forces. The primary purpose of these bearings N1, N2 is to center and mount the planetary carrier 3 in the epicyclic gear housing U. Snug-fit seats S1, S2 are formed in the gear housing G, wherein shaft seals (not illustrated) can be inserted into the same. These serve the purpose of sealing the gear housing from the insert shaft.

The functionality of the differential gear according to the invention is as follows: The ring gear 7 is driven by the primary drive sprocket 8. The ring gear 7 is fixed to the epicyclic gear housing U in a manner preventing rotation. Accordingly, the epicyclic gear housing U is made to rotate via the ring gear 7. This epicyclic gear housing U is arranged concentrically to a gear axle X, and mounted in the gear housing G via the first and the second bearings L1, L2 in a manner allowing rotation.

The brake disk rings 4b of the brake disk pack BLP which are also coupled to the epicyclic gear housing U in a non-rotatable manner rotate together with the same. The brake disk pack BLP is loaded axially by the pressure ring 4d and the annular plate 4c according to the magnitude of the axial force F generated by the actuating mechanism 5, and are thereby optionally brought into a coupled state in which the epicyclic gear housing U and the planetary carrier 3 are coupled by a friction fit. A division of power is realized inside the planetary carrier 3 via the planets P1, P2 and the output sun gears 1, 2.

The planetary gear train accommodated in this case in the epicyclic gear housing U forms a spur gear differential, as already described. In the embodiment shown here, the output sun gear 1, 2 and the planet gears P1, P2 of the planetary arrangement P are configured with a Wildhaber/Novikov toothing. The first output sun gear 1 in this case has a toothing with a small addendum circle and concave tooth flank surfaces. The second output sun gear 2 has a toothing with a large addendum circle and convex tooth flank surfaces. The addendum circle diameter of the first output sun gear 1, and theoretic root circle of the second output sun gear 2 approximately correspond to the same, identical semicircle diameter. Both gears 1, 2 have the same number of teeth. The first output sun gear 1 engages with the revolving planets P1. The second output sun gear 2 engages with the revolving planets P2. The revolving planets P1 have a large addendum circle diameter, and form convex tooth flanks. The revolving planets P2 have a small addendum circle diameter and form concave tooth flanks. The revolving planets P1, P2 engage with each other in pairs. The engagement occurs in the engagement plane of the first revolving planets P1 with the first output sun gear 1. The first revolving planets P1 have an axial length which corresponds substantially to the axial length of the toothing 1a of the first output sun gear 1. The second revolving planets P2 have an axial length which corresponds substantially to the sum of the axial lengths of the toothings 1a, 2a of the two output sun gears 1, 2.

The planet pins 6 are supported axially on the pressure ring element R. This pressure ring element R is in turn supported by the plunger elements Q1 which are guided in the base wall U2a of the bowl housing in a manner allowing axial sliding. The plunger elements Q1 are supported axially on the race R1 of the first axial bearing AX1. The rollers L1r of this first axial bearing AX1 roll directly on a circular end face F1 of the outer bearing ring of the cylindrical roller bearing L1, which as such only bears the epicyclic gear housing U radially in the gear housing G.

The outer bearing ring L1a, the axial bearing AX1, the planet pins 6, and the brake disk pack BLP are matched to each other and designed in such a manner that there is a substantially straight-line transmission of axial force through the planetary carrier, and the transfer of force into the gear housing G occurs at the radial distance of the brake disk pack BLP.

What is claimed is:

1. A differential gear, comprising:
a gear housing (G);
an epicyclic gear housing (U) which is arranged in the gear housing (G) in a manner allowing rotation about a gear axis (X);
a bearing device (L1, L2) for the purpose of mounting the epicyclic gear housing (U) in the gear housing (G);
a planetary carrier (3) arranged in the epicyclic gear housing (U) coaxially to the gear axle (X);
a brake device having a brake disk pack (BLP) for the purpose of generating a coupling torque which couples the planetary carrier (3) to the epicyclic gear housing (U); and,
an actuating mechanism (5) for the purpose of generating an axial force (F) which engages the brake device, wherein the bearing device (L1, L2) has a first roller bearing (L1) with an outer bearing ring (L1a) fixed to the gear housing (G), and the axial force (F) which engages the brake device is guided via a first axial bearing (AX1) which is supported on a radial end face (F1) of the first outer bearing ring (L1a) of the first roller bearing (L1).

2. The differential gear recited in claim 1, wherein the first roller bearing (L1) is designed as a roller bearing which bears axially and radially, particularly as an angular roller bearing or a tapered roller bearing.

3. The differential gear recited in claim 2, wherein the first axial bearing (AX1) is designed as a cylinder roller bearing, and in that the cylinder rollers (L1r) of this cylinder roller bearing roll directly on the end face (F1) of the first outer bearing ring (L1a).

4. The differential gear recited in claim 3, wherein the first axial bearing (AX1) has a first axial bearing race (R1), wherein the roller elements (L1r) of the first axial bearing (AX1) are axially supported on said axial bearing race (R1), on a side which is opposite the outer bearing ring (L1a) of the first roller bearing (L1).

5. The differential gear recited in claim 1, wherein a second axial bearing (AX2) is configured on a side of the epicyclic gear housing (U) which is opposite the first axial bearing (AX1).

6. The differential gear recited in claim 5, wherein the second axial bearing (AX2) has a second axial bearing race (R2), and in that the rollers L2r of this second axial bearing (AX2) roll on the end face of an annular piston (RK).

7. The differential gear recited in claim 1, wherein the differential gear is designed as a spur gear differential, and has a first output sun gear (1), a second output sun gear (2), and a planetary arrangement (P) received in the planetary carrier (3) for the purpose of coupling the two output sun gears (1, 2) in a manner allowing rotation is opposite directions.

8. The differential gear recited in claim 7, wherein the planetary arrangement (P) has multiple revolving planets (P1, P2) which as such are able to rotate about planet axes (XP) which are oriented parallel to the gear axle (X), and the brake device is designed in such a manner that the brake disk pack (BLP) is positioned at the radial distance of the planet axes (XP1).

9. The differential gear recited in claim 1, wherein the raceway of the first axial bearing race (R1), the same bearing radially, is positioned at the radial distance of the brake disk pack (BLP).

10. The differential gear recited in claim 1, wherein the epicyclic gear housing (U) is designed as a bowl housing, and in that the transmission of axial force between the planetary carrier (3) and the first axial bearing race (R1) occurs via plunger elements (Q1) which are guided with axial float through a base surface (U2a) of the bowl housing (U).
